(19) United States
(12) Patent Application Publication
(10) Pub. No.: US 2017/0347841 A1
(43) Pub. Date: Dec. 7, 2017

(54) Bathing Chair Assembly

(71) Applicants: Clarence Nera, Vancouver, WA (US); Jeanne Nera, Vancouver, WA (US)

(72) Inventors: Clarence Nera, Vancouver, WA (US); Jeanne Nera, Vancouver, WA (US)

(21) Appl. No.: 15/175,153

(22) Filed: Jun. 7, 2016

(51) Int. Cl. A47K 3/28; A47C 7/40; A47C 7/00; A47C 7/16; F16B 7/10; A47C 7/54

(52) U.S. Cl. CPC A47K 3/282; F16B 7/105; A47C 7/54; A47C 7/008; A47C 7/16; A47C 7/40

(57) ABSTRACT

A bathing chair assembly for sitting level on an uneven surface includes a chair that may be positioned in a shower thereby facilitating the chair to support a physically disabled user in the shower. A plurality of legs is provided and each of the legs is removably coupled to the chair. Thus, each of the legs may support the chair in the shower. Each of the legs is positioned at a selected height with respect to the chair. Thus, the chair may sit level on an uneven surface.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art including information disclosed under 37 CFR 1.97 and 1.98.

The disclosure and prior art relates to chair devices and more particularly pertains to a new chair device for sitting level on an uneven surface.

### BRIEF SUMMARY OF THE INVENTION

An embodiment of the disclosure meets the needs presented above by generally comprising a chair that may be positioned in a shower thereby facilitating the chair to support a physically disabled user in the shower. A plurality of legs is provided and each of the legs is removably coupled to the chair. Thus, each of the legs may support the chair in the shower. Each of the legs is positioned at a selected height with respect to the chair. Thus, the chair may sit level on an uneven surface.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a bathing chair assembly according to an embodiment of the disclosure.

FIG. 2 is a back exploded view of an embodiment of the disclosure.

FIG. 3 is a front view of an embodiment of the disclosure.

FIG. 4 is a cross sectional view taken along line 4-4 of FIG. 1 of an embodiment of the disclosure.

FIG. 5 is a perspective in-use view of an embodiment of the disclosure.

### DETAILED DESCRIPTION OF THE INVENTION

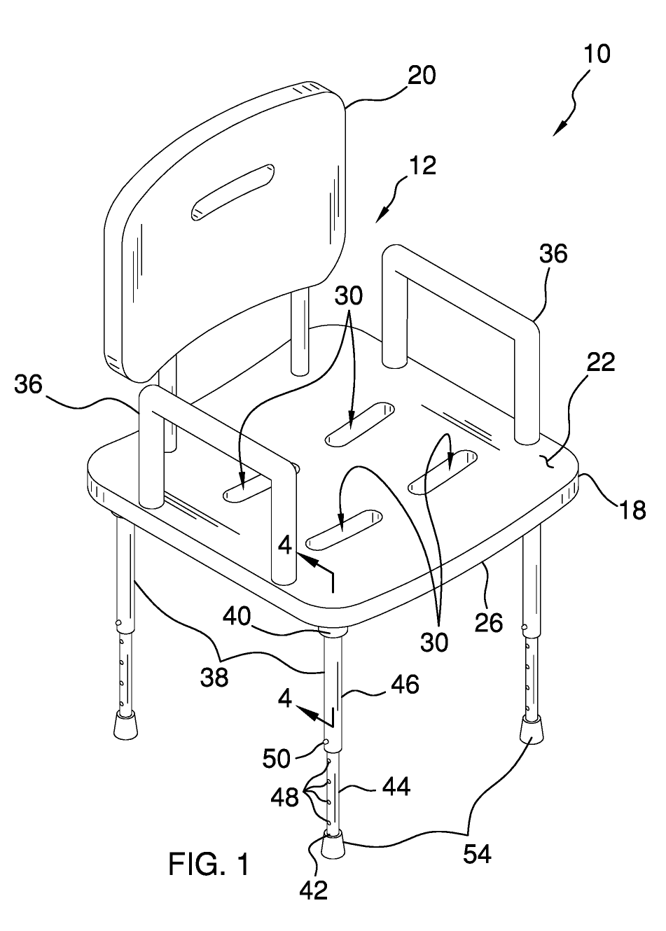

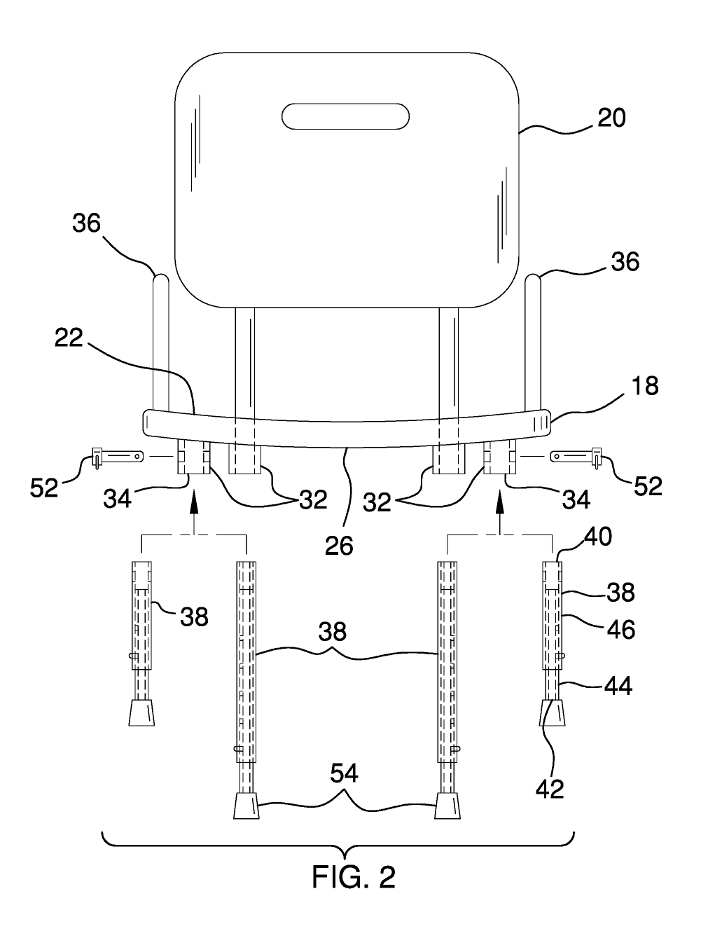

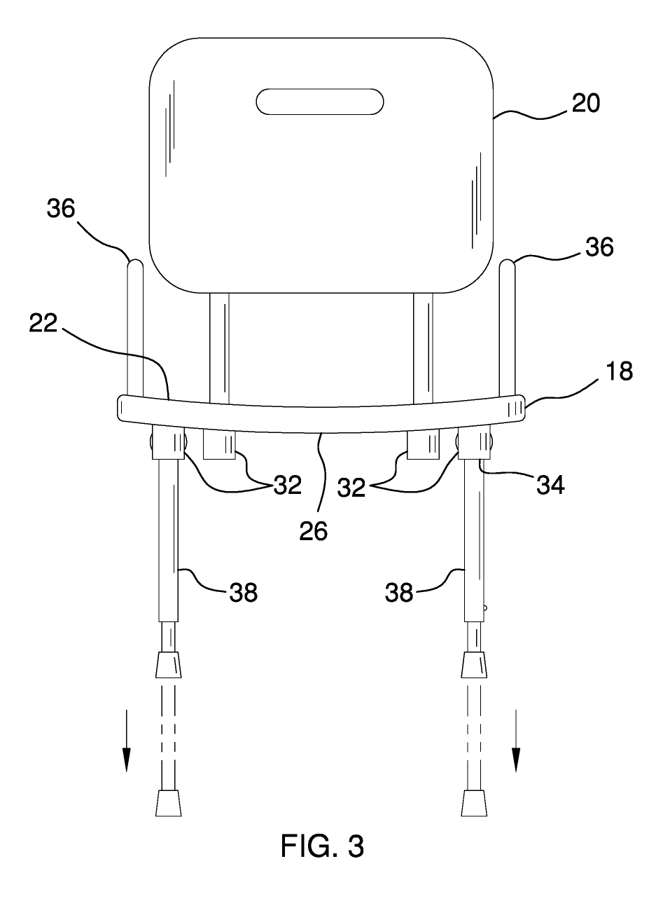

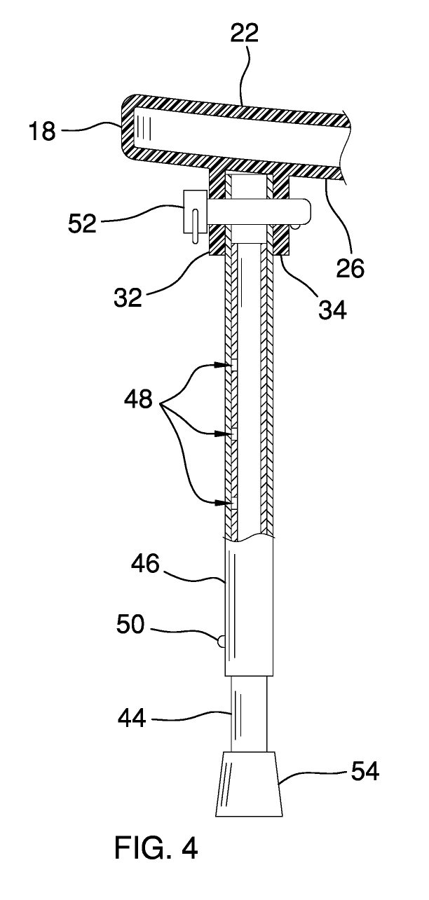

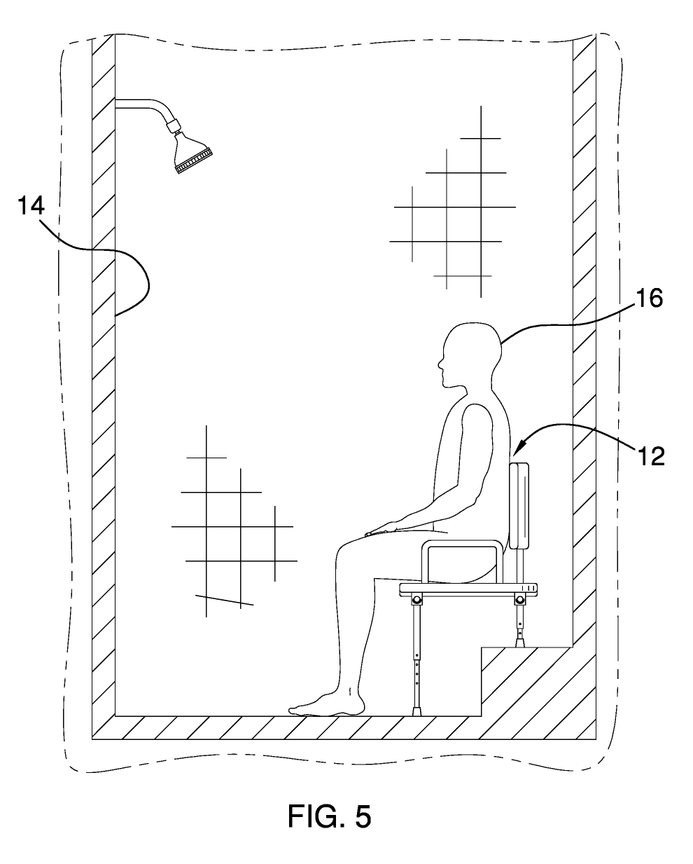

With reference now to the drawings, and in particular to FIGS. 1 through 5 thereof, a new chair device embodying the principles and concepts of an embodiment of the disclosure and generally designated by the reference numeral 10 will be described.

As best illustrated in FIGS. 1 through 5, the bathing chair assembly 10 generally comprises a chair 12 that may to be positioned in a shower 14. The shower 14 may be a bathing shower or the like. Thus, the chair 12 may support a physically disabled user 16 in the shower 12. The chair 12 has a seat 18 and a back rest 20.

The seat 18 has a top surface 22 and a bottom surface 26. The seat 18 has a plurality of slots 30 extending through the top surface 22 and the bottom surface 26. Thus, each of the slots 30 may have a fluid drain therethrough when the chair 12 is positioned in the shower. The slots 30 are spaced apart from each other and are distributed on the seat 18. The back rest 20 is coupled to and extends upwardly the top surface 22 of the seat 18.

A plurality of sleeves 32 is provided. Each of the sleeves 32 is coupled to and extends downwardly from the bottom surface 26 of the seat 18. Each of the sleeves 32 has a distal end 34 with respect to the bottom surface 26. The distal end 34 corresponding to each of the sleeves 32 is open. Each of the sleeves may be aligned with an associated one of four corners of the seat.

A pair of arms rests 36 is provided. Each of the arms rests 36 is coupled to and extending upwardly from the seat 18. Each of the arms rests 36 is oriented coextensive with opposite sides of a perimeter of the seat 18. Moreover, each of the arm rests 36 may comprise a pair of spaced uprights and a central member.

A plurality of legs 38 is provided and each of the legs 38 is removably coupled to the chair 12. Thus, each of the legs 38 may support the chair 12 in the shower. Each of the legs 38 is positioned at a selected height with respect to the chair 12. Thus, the chair 12 may sit level on an uneven surface.

Each of the legs 38 has a first end 40 and a second end 42. Each of the legs 38 comprises a first section 44 slidably coupled to a second section 46. Thus, each of the legs 38 has a telescopically adjustable length. The first section 44 corresponding to each of the legs 38 has a plurality of apertures 48 extending therethrough. The apertures 48 are spaced apart from each other and are distributed along the first section 44.

A lock 50 is movably coupled to the second section 46 corresponding to each of the legs 38. The lock 50 is biased to engage a selected one of the apertures 48 in the corresponding leg 38. Thus, the corresponding leg 38 is retained at a selected length.

A plurality of pins 52 is provided and each of the pins 52 may be manipulated. Each of the pins 52 extends through an associated one of the sleeves 32 and engages an associated one of the legs 38. Thus, the associated leg 38 is retained in the associated sleeve 32. A plurality of feet 54 is provided and each of the feet 54 is coupled to the second end 42 of an associated one of the legs 38. Each of the feet 54 frictionally engages the shower 14 thereby inhibiting the chair from sliding in the shower.

In use, each of the legs 38 is inserted into the associated sleeve 32. Each of the pins 52 is manipulated to retain the legs 38 in the sleeves 32. Each of the legs 38 is adjusted to a selected height. Thus, the chair 12 may be positioned to extend between un-even surfaces in the shower 14 such as a floor and a built in shower seat or the like. The physically disabled user 16 sits on the seat 18 while bathing.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A bathing chair assembly being configured to facilitate a physically disabled user to shower, said assembly comprising:
a chair being configured to be positioned in a shower thereby facilitating said chair to support a physically disabled user in the shower, said chair having a seat and a back rest, said seat having a top surface and a bottom surface, said seat having a plurality of slots extending through said top surface and said bottom surface wherein each of said slots is configured to have a fluid drain therethrough when said chair is positioned in the shower, said slots being spaced apart from each other and being distributed on said seat, said back rest being coupled to and extending upwardly said top surface of said seat;
a plurality of sleeves, each of said sleeves being coupled directly to and extending downwardly from said bottom surface of said seat, each of said sleeves having a distal end with respect to said bottom surface, said distal end corresponding to each of said sleeves being open;
a plurality of legs, each of said legs being removably coupled to said chair wherein each of said legs is configured to support the chair in the shower, each of said legs being positioned at a selected height with respect to said chair wherein said chair is configured to sit level on an uneven surface, each of said legs having a first end and a second end, said first end corresponding to each of said legs being slidably inserted into an associated one of said sleeves such that said sleeves hold said plurality of legs in a fixed position relative to said seat and parallel to each other; and
a plurality of pins, each of said pins being configured to be manipulated, each of said pins extending through an associated one of said sleeves and engaging an associated one of said legs such that said associated leg is retained in said associated sleeve and said associated leg is held in a substantially perpendicular position relative to said seat.

2. (canceled)

3. (canceled)

4. The assembly according to claim 1, further comprising a pair of arm rests, each of said arm rests being coupled to and extending upwardly from said seat, each of said arm rests being oriented coextensive with opposite sides of a perimeter of said seat.

5. (canceled)

6. The assembly according to claim 1, wherein each of said legs comprises a first section being slidably coupled to a second section such that each of said legs has a telescopically adjustable length, said first section corresponding to each of said legs having a plurality of apertures extending therethrough, said apertures being spaced apart from each other and being distributed along said first section, said second section corresponding to each of said legs having a lock being movably coupled thereto, said lock being biased to engage a selected one of said apertures in said corresponding leg such that the corresponding leg is retained at a selected length.

7. (canceled)

8. The assembly according to claim 1, further comprising a plurality of feet, each of said feet being coupled to said second end of an associated one of said legs.

9. A bathing chair assembly being configured to facilitate a physically disabled user to shower, said assembly comprising:
a chair being configured to be positioned in a shower thereby facilitating said chair to support a physically disabled user in the shower, said chair having a seat and a back rest, said seat having a top surface and a bottom surface, said seat having a plurality of slots extending through said top surface and said bottom surface wherein each of said slots is configured to have a fluid drain therethrough when said chair is positioned in the shower, said slots being spaced apart from each other and being distributed on said seat, said back rest being coupled to and extending upwardly said top surface of said seat;
a plurality of sleeves, each of said sleeves being coupled directly to and extending downwardly from said bottom surface of said seat, each of said sleeves having a distal end with respect to said bottom surface, said distal end corresponding to each of said sleeves being open;
a pair of arm rests, each of said arm rests being coupled to and extending upwardly from said seat, each of said arm rests being oriented coextensive with opposite sides of a perimeter of said seat;
a plurality of legs, each of said legs being removably coupled to said chair wherein each of said legs is configured to support the chair in the shower, each of said legs being positioned at a selected height with respect to said chair wherein said chair is configured to sit level on an uneven surface, each of said legs having a first end and a second end, said first end corresponding to each of said legs being slidably inserted into an associated one of said sleeves such that said sleeves hold said plurality of legs in a fixed position relative to said seat and parallel to each other, each of said legs comprising a first section being slidably coupled to a second section such that each of said legs has a telescopically adjustable length, said first section corresponding to each of said legs having a plurality of apertures extending therethrough, said apertures being spaced apart from each other and being distributed along said first section, said second section corresponding to each of said legs having a lock being movably coupled thereto, said lock being biased to engage a selected one of said apertures in said corresponding leg such that the corresponding leg is retained at a selected length;
a plurality of pins, each of said pins being configured to be manipulated, each of said pins extending through an associated one of said sleeves and engaging an associated one of said legs such that said associated leg is retained in said associated sleeve and said associated leg is held in a substantially perpendicular position relative to said seat; and
a plurality of feet, each of said feet being coupled to said second end of an associated one of said legs.
